(19) United States
(12) Patent Application Publication
(10) Pub. No.: US 2025/0007006 A1
(43) Pub. Date: Jan. 2, 2025

(54) Method for at Least Partially Recycling and/or Repairing an Electrical Energy Accumulator

(71) Applicant: Bayerische Motoren Werke Aktiengesellschaft, Muenchen (DE)

(72) Inventors: Stefan KERSCHER, Dorfen (DE); Stephan MAIER, Roehrmoos (DE); Werner SELIGER, Hallbergmoos (DE); Andreas STEMP, Muenchen (DE)

(21) Appl. No.: 18/708,657

(22) PCT Filed: Jan. 26, 2023
(86) PCT No.: PCT/EP2023/051906

§ 371 Date: May 9, 2024

(30) Foreign Application Priority Data
Feb. 17, 2022 (DE) 10 2022 103 744.4

(51) Int. Cl. H01M 10/42; H01M 10/48; H01M 10/54; H01M 50/474; H01M 50/514

(52) U.S. Cl. CPC H01M 10/4207; H01M 10/482; H01M 50/474; H01M 50/514; H01M 10/54

(57) ABSTRACT

A method is provided for at least partially recycling and/or repairing an electrical energy accumulator having at least one cell arrangement consisting of a plurality of electrical energy accumulator cells joined in an accumulator housing of the electrical energy accumulator by means of a filling. In the method, in order to remove at least one energy accumulator cell of the at least one cell arrangement from the filling that at least partially surrounds the energy accumulator cells, the at least one energy accumulator cell is released from the filling by at least one magnet which acts on a cell housing of the at least one energy accumulator cell.

### BACKGROUND AND SUMMARY

The invention relates to a method for at least partially recycling and/or repairing an electrical energy store having at least one cell assembly consisting of a plurality of electrical energy storage cells which are joined in a store housing of the electrical energy store by means of a filling.

In the present case, interest focuses on electrical energy stores which can be used, for example, as traction batteries for electrified motor vehicles, that is to say electric or hybrid vehicles. An electrical energy store of this type usually has a store housing, in the receiving space of which at least one cell assembly consisting of a plurality of energy storage cells which are interconnected with one another is arranged. It is known here from the prior art, for example EP 0 454 017 B1, for the energy storage cells to be embedded for securing purposes in a filling, for example a cured casting compound or a bulk material.

DE 10 2007 010 742 B4 also discloses a cell assembly consisting of battery cells, in which cell assembly the battery cells are fixed by means of a casting compound.

In the case where at least one of the energy storage cells is defective, it can occur that the entire energy store has to be disposed of, since a separation or release of the energy storage cells from the filling is not possible or is possible only with high complexity on account of the usually strongly bound adhesive connection between the filling and cell housings of the energy storage cells. This is undesirable, in particular, for sustainability reasons.

It is an object of the present invention to provide a solution for at least partially recycling and/or repairing an electrical energy store.

According to the invention, this object is achieved by way of a method according to the independent claim(s). Advantageous embodiments of the invention are the subject matter of the dependent claims, the description and the figures.

A method according to the invention serves for at least partially recycling and/or repairing an electrical energy store which has at least one cell assembly consisting of a plurality of electrical energy storage cells which are joined in a store housing of the electrical energy store by means of a filling. At least one energy storage cell of the at least one cell assembly is removed, in the case of the method, from the filling which at least partially surrounds the energy storage cells, by the at least one energy storage cell being released, in particular pulled out or pressed out, from the filling by means of at least one magnet which acts on a cell housing of the at least one energy storage cell.

The electrical energy store is, in particular, a rechargeable traction battery, preferably a high voltage energy store, for an electrified motor vehicle. The electrical energy store can have a plurality of cell assemblies or cell packages which are interconnected with one another and of which each cell assembly or each cell package has a plurality of energy storage cells which are interconnected with one another. The energy storage cells are preferably round cells which each have a cell housing with a cylindrical shell surface and two circular cover surfaces. A galvanic element of the energy storage cell is arranged in the cell housing. The one cover surface configures a cell lid which can have, for example, cell poles or cell terminals of the energy storage cell. The other cover surface configures a cell bottom which can have, for example, a degassing element for discharging a hot gas in the case of a thermal event of the energy storage cell. The cell housings of the energy storage cells are configured, in particular, from a metal. In order to configure the at least one cell assembly, the round cells are arranged, for example, upright in a receiving space of a store housing of the electrical energy store, with the result that an upper side of the cell assembly is formed by way of the cell lids and a lower side of the cell assembly is formed by way of the cell bottoms of the energy storage cells.

In order to interconnect the energy storage cells, a cell contacting system is arranged on that side of the at least one cell assembly which has the cell poles, for example the upper side of the at least one cell assembly, and is connected electrically and mechanically, for example welded, to the cell poles. It can be provided here that the energy storage cells are connected in series within a cell assembly by means of the cell contacting system, and a plurality of cell assemblies are connected in parallel.

Inter alia, in order to fix or join the energy storage cells in the receiving space, the at least one cell assembly is embedded into a filling. The filling is formed by way of at least partial filling of the receiving space with a filler. The filler is preferably a foam. Here, the filler surrounds the at least one cell assembly at least partially. In particular, the filler is arranged in the cell intermediate spaces between the shell surfaces of the energy storage cells and, moreover, covers the upper side of the cell assembly, with the result that the cell contacting system is also embedded into the filling. The filling can also cover the lower side of the at least one cell assembly, on which lower side the degassing elements of the energy storage cells can be arranged. Moreover, a filler of this type increases the rigidity of the electrical energy store, and protects the energy storage cells in the case of an accident-induced action of force, for example in the case of a side crash, with the result that a short-circuit between energy storage cells can be prevented.

In order to recycle the electrical energy store, for example at the end of the service life of the energy storage cells, all the energy storage cells are to be released from the filling or separated from the filling. The released energy storage cells can be waste products or can serve as starting materials for further use. In order to repair the electrical energy store in the case of a defect of at least one energy storage cell, only this energy storage cell or at most the cell assembly, in which the defective energy storage cell is arranged, is to be separated from the filling. Here, the separation takes place magnetically, either by means of magnet separation or eddy current separation. To this end, at least one magnet is used, by which the cell housings of the energy storage cells are attracted or repelled, depending on their material. The at least one magnet can be, for example, a permanent magnet or an electromagnet. In the case of the use of the magnet, moreover, suitable measures can be taken, in order to prevent electrical short circuits between different electrical potentials.

In the case of ferromagnetic materials of the cell housings, the cell housings are attracted by the magnet, and the energy storage cells can be pulled out of the filling, this form of magnetic separation being called magnet separation. In the case where the cell housings consist of an electrically conducting but non-magnetic material, the cell housings are repelled by the magnet, and the energy storage cells can be pressed out of the filling, this form of magnetic separation being called eddy current separation.

A particularly sustainable electrical energy store can be provided in an advantageous way by way of a process of this type of the release of the individual energy storage cells from a filling.

In order to release the at least one energy storage cell from the filling, the at least one magnet is preferably attached to a cover surface of the cell housing of the at least one energy storage cell. In the case where the filling is arranged not only in the cell intermediate spaces, but rather also covers the upper side and/or the lower side of the cell assembly, the filling is removed, in particular, at least in the region of at least one of the cover surfaces of the cell housing before the release of the at least one energy storage cell. For example, the filling can be removed by means of a punching tool by way of being punched out. The punching tool is, in particular, an electrically non-conducting tool. By way of the punching out operation, a channel for the at least one energy storage cell is formed in the filling, through which channel the energy storage cell can be moved out of the filling by means of the at least one magnet. In the case where the energy storage cell is pulled out of the filling by means of the at least one magnet, the filling is removed at that cover surface, to which the magnet is also applied. In the case where the energy storage cell is pressed out of the filling by means of the at least one magnet, the filling is removed at least at the cover surface which lies opposite the magnet. Before the release of the at least one energy storage cell to be removed, moreover, the cell contacting system which interconnects the energy storage cells is removed at least in the region of the at least one energy storage cell to be removed.

It proves to be advantageous if, in the case of the production of the electrical energy store, a casing layer is arranged on the cell housings of the energy storage cells and/or on the cell contacting system, by way of which casing layer, during the filling of the store housing with the filler, no adhesive connection is produced between the filling and the cell housings and/or between the filling and the cell contacting system. Therefore, although the energy storage cells are fixed in the receiving space by way of the filling, no adhesive connection arises between the cell housings and the filler of the filling on account of the casing layer. The casing layer can be, for example, a film, in particular a plastic film, which surrounds the cell housings and/or the cell contacting system at least in regions. The casing layer can also be a coating of the cell housings and/or the cell contacting system.

In one development of the invention, in order to repair the electrical energy store in the case of at least one defective energy storage cell, the defective energy storage cell is localized and is removed by means of the at least one magnet. Subsequently, a new, functional energy storage cell is inserted into a cavity of the filling, which cavity has arisen as a result of removal of the defective energy storage cell. After insertion of the new, functional energy storage cell, the filling can be completed again, for example by filler again being introduced into the receiving space, which filler surrounds the new energy storage cell at least in regions and therefore holds it in the receiving space.

It can be provided here that the at least one defective energy storage cell is identified on the basis of signals of a monitoring sensor system of the energy storage cells, and is localized in the filling by means of a template which is placed onto the at least one cell assembly which is surrounded by the filling, and/or by way of distance measurement with use of a known layout of the electrical energy store. A monitoring sensor system of this type can be provided at each energy storage cell or at each cell assembly, and can be configured, for example, to monitor a temperature, a cell (assembly) voltage, a cell (assembly) current, etc. The monitoring sensor systems of the energy storage cells can communicate, for example, with a control unit of the electrical energy store, which control unit detects a defect of at least one energy storage cell on the basis of the signals of the monitoring sensor systems. As soon as this at least one defective energy storage cell has been identified, its installation location in the receiving space of the store housing is determined, in order for it to be possible for it to be removed. Here, for example, a template can be used, or the receiving space of the store housing can be measured.

Further features of the invention result from the claims, the figures and the description of the figures. The features and combinations of features mentioned above in the description and the features and combinations of features mentioned below in the description of the figures and/or shown only in the figures can be used not only in the respective specified combination, but rather also in other combinations or on their own.

The invention will now be explained in greater detail on the basis of one preferred exemplary embodiment and with reference to the drawings.

### BRIEF DESCRIPTION OF THE DRAWINGS

FIG. 1 is a diagrammatic illustration of an electrical energy store;

FIGS. 2a to 2d are diagrammatic illustrations of steps for the removal of at least one energy storage cell of the electrical energy store according to FIG. 1; and

FIGS. 3a to 3d are diagrammatic illustrations of steps for the introduction of at least one new energy storage cell for a repair of the electrical energy store according to FIG. 1.

In the figures, identical and functionally identical elements are provided with the same designations.

### DETAILED DESCRIPTION OF THE DRAWINGS

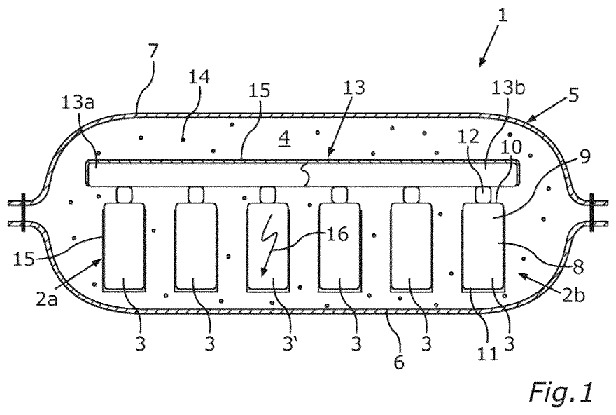

FIG. 1 shows an electrical energy store 1 for a motor vehicle. Here, the electrical energy store 1 has a plurality of cell assemblies 2a, 2b consisting of energy storage cells 3, 3′ which are configured here as round cells and are arranged upright in a receiving space 4 of a store housing 5 of the electrical energy store 1. The store housing 5 has a housing bottom 6 and a housing lid 7 which are connected mechanically and close off the receiving space 4. The energy storage cells 3, 3′ have cell housings 8 with a cylindrical cell shell 9, a first cover surface 10 in the form of a cell lid, and a second cover surface 11 in the form of a cell bottom. Cell poles 12 of the energy storage cells 3, 3′ are arranged on the cell lids 10, which cell poles 12 are connected electrically by means of a cell contacting system 13 in order to interconnect the energy storage cells 3, 3′. The cell contacting system 13 can have, for example, cell connectors which are welded to the cell poles 12.

Moreover, the receiving space 4 is filled with a filling 14 which surrounds the cell assemblies 2a, 2b completely here. As a result, the energy storage cells 3, 3′ and the cell contacting system 13 are embedded into the filling 14. The filling 14 is, in particular, a foam. In order to prevent an adhesive connection between the filling 14 and the cell housings 8 and between the filling 14 and the cell contacting system 13, the energy storage cells 3 and the cell contacting system 13 are surrounded at least in regions by a casing layer 15, for example a plastic film. This casing layer 15 is therefore arranged between the cell housings 8 or the cell contacting system 13 and the filling 14. In order to increase the thermal conductivity between the energy storage cells 3, 3′ and a cooler (not shown here) of the electrical energy store 1, a heat conducting adhesive can be arranged between the casing layer 15 which surrounds the cell housings 8 and the filling 14.

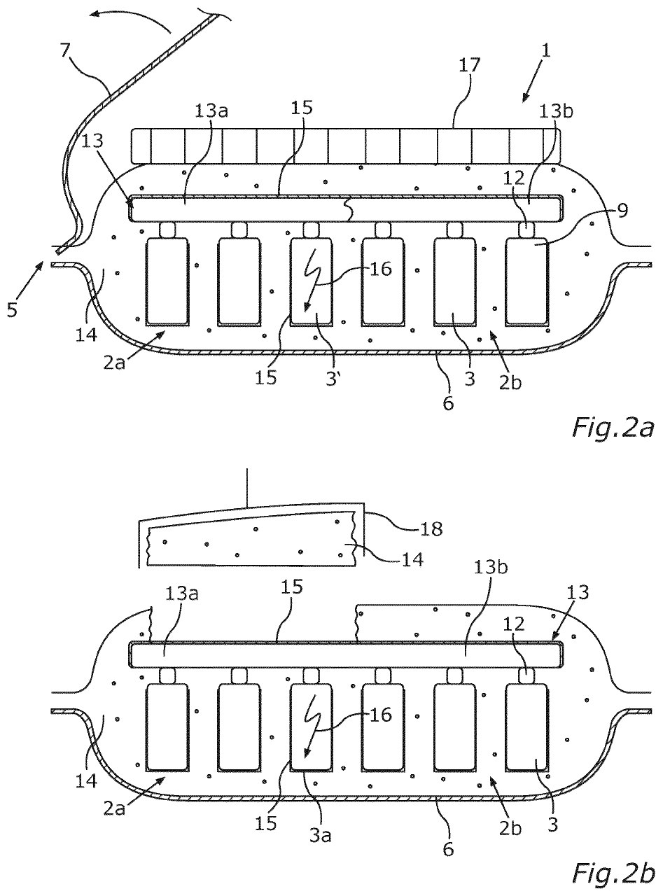

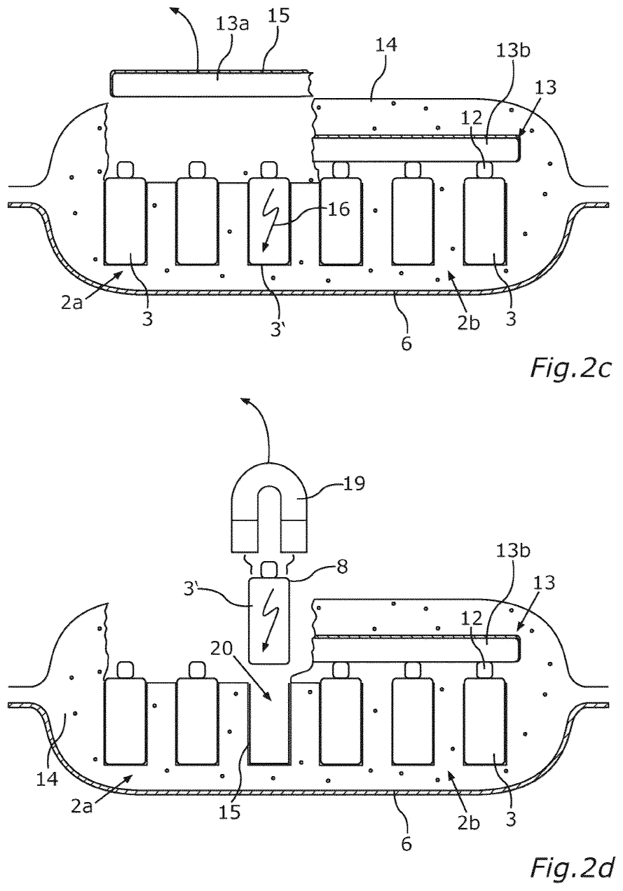

Here, the energy storage cell 3′ of the cell assembly 2a has a defect 16 which impairs a functionality of the entire electrical energy store 1. When the defect 16 has been detected, for example, by a monitoring sensor system, the driver of the motor vehicle, for example, can be instructed to visit a service center. In order to prevent it being necessary for the entire energy store 1 to be disposed of, at least the defective energy storage cell 3′ or the relevant cell block 2a, in which the defective energy storage cell 3′ is arranged, can be released magnetically from the filling 14 by way of the steps described in the FIGS. 2a to 2d, and can therefore be removed. To this end, the store housing 4 is opened, by, as shown in FIG. 2a, the housing lid 7 being removed, for example. An installation location of the defective energy storage cell 3 can be found, for example, by means of a template 17, and therefore the defective energy storage cell 3′ or the relevant cell block 2a can be localized in the filling 14.

As shown in FIG. 2b, the filling 14 is removed at least above the defective energy storage cell 3′, here above the defective cell block 2a. For example, the filling 14 can be “cut out” by means of a non-conducting punching tool 18, and can therefore be removed. On account of the absence of an adhesive connection between the cell contacting system 13 and the filling 14 as a result of the casing layer 15, the filling 14 is released easily from the cell contacting system 13.

In a next step which is shown in FIG. 2c, that region 13a of the cell contacting system 13 which belongs to the defective cell assembly 2a is separated from that region 13b of the cell contacting system 13 which belongs to the functional cell assembly 2b, and the region 13a is removed. The energy storage cells 3, 3′ of the defective cell assembly 2a are therefore disconnected. FIG. 2d shows the magnetic release of the defective energy storage cell 3′ from the filling 14. Here, the energy storage cells 3, 3′ have a magnetic cell housing 8. Therefore, the defective energy storage cell 3′ can be pulled out of the filling 14 by means of a magnet 19, it being possible for the casing layer 15 to remain at least partially in the filling 14.

In the case where the energy store 1 is to be completely recycled, the filling 14 and the cell contacting system 13 above the cell assemblies 2a, 2b are removed after opening of the store housing 4, and the energy storage cells 3, 3′ are pulled out of the filling 14 either individually one after another or several at the same time by means of one or more magnets 19.

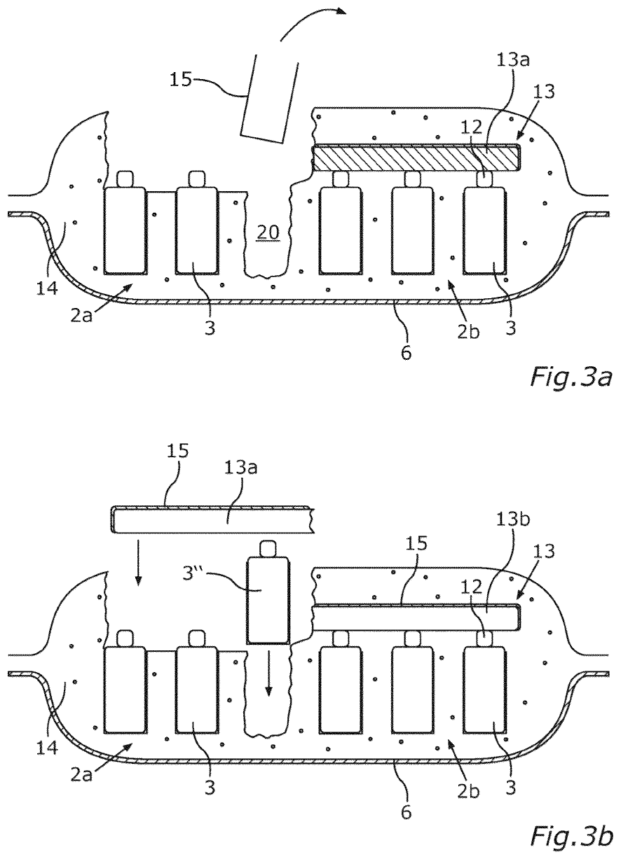

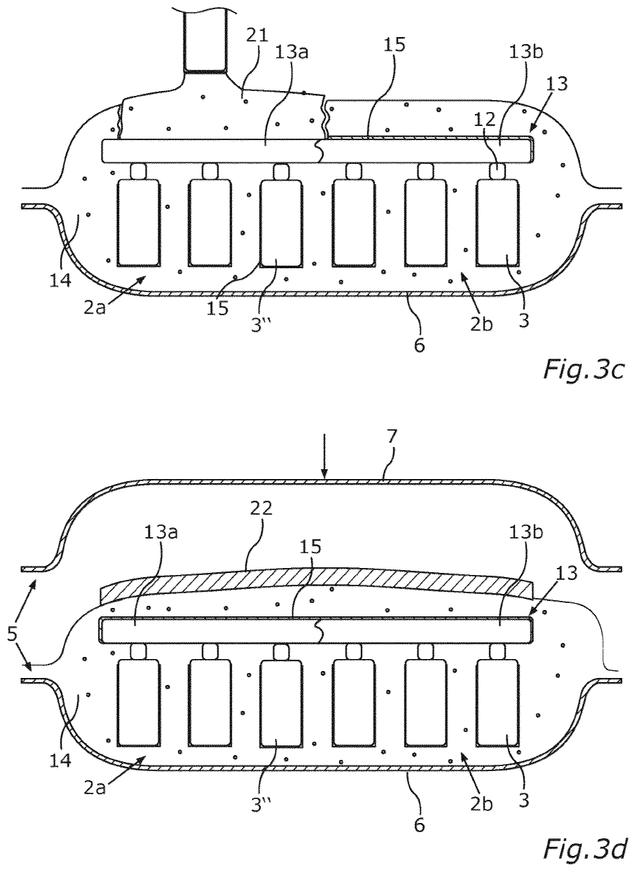

For the case where the energy store 1 needs to be repaired, as shown in FIG. 3a, a remaining location or a cavity 20 in the filling 14 which arises as a result of release of the defective energy storage cell 3′ is cleaned. To this end, the casing material 15 of the defective energy storage cell 3′, which casing material 15 can have remained in the filling 14, and possibly the heat-conducting adhesive are removed as far as possible. Then, as shown in FIG. 3b, a new, non-defective energy storage cell 3″, the cell housing 8 of which is likewise covered in regions with a casing layer 15, is inserted into the remaining location 20, and the cell contacting system 13 is attached to the new energy storage cell 3″, by the region 13a again being connected electrically to the cell assembly 2a. In order to ensure functionality of the repaired energy store 1, electrical tests can be carried out. Moreover, the filling 14 is produced again, as in FIG. 3c, by new filler 21 being introduced into the receiving space 4, and the cell assembly 2a being foamed again, at least partially. Then, as shown in FIG. 3d, adhesive 22 can be applied over a large area on a surface of the filling 14, and the housing lid 7 can be placed on top and adhesively bonded. Subsequently, the electrical energy store 1 can be used further.

1.-8. (canceled)

9. A method for at least partially recycling and/or repairing an electrical energy store having at least one cell assembly with a plurality of electrical energy storage cells that are joined in a store housing of the electrical energy store via a filling, the method comprising:
removing at least one energy storage cell of the at least one cell assembly from the filling that at least partially surrounds the plurality of energy storage cells, wherein
the at least one energy storage cell is released from the filling via at least one magnet acting on a cell housing of the at least one energy storage cell to be removed.

10. The method according to claim 9, wherein
in order to release the at least one energy storage cell from the filling, the at least one magnet is attached to a cover surface of the cell housing of the at least one energy storage cell to be removed.

11. The method according to claim 9, wherein
before the release of the at least one energy storage cell, the filling is removed at least in a region of the cover surface of the cell housing of the at least one energy storage cell.

12. The method according to claim 11, wherein
the filling is removed via a punching tool by way of being punched out.

13. The method according to claim 10, wherein
before the release of the at least one energy storage cell, a cell contacting system which interconnects the energy storage cells is removed at least in a region of the at least one energy storage cell to be removed.

14. The method according to claim 9, wherein
in order to repair the electrical energy store in the case of at least one defective energy storage cell, the defective energy storage cell is localized and is removed by the at least one magnet, and
a new, functional energy storage cell is inserted into a cavity of the filling, which cavity arises as a result of the removing of the defective energy storage cell.

15. The method according to claim 14, wherein
the at least one defective energy storage cell is identified based on signals of a monitoring sensor system of the plurality of energy storage cells, and is localized in the filling by way of:
a template which is placed onto the at least one cell assembly which is surrounded by the filling, and/or
a distance measurement with use of a known layout of the electrical energy store.

16. The method according to claim 9, wherein
in producing the electrical energy store, a casing layer is arranged on the cell housings of the plurality of energy storage cells and/or on a cell contacting system which interconnects the plurality of energy storage cells, by way of which casing layer, during filling of the store housing with a filler in order to configure the filling, an adhesive connection between the filling and the cell housings and/or between the filling and the cell contacting system is prevented.
